(19) United States
(12) Patent Application Publication
(10) Pub. No.: US 2002/0071041 A1
(43) Pub. Date: Jun. 13, 2002

(54) Enhanced resolution mode using color image capture device

(76) Inventor: Joshua I. Pine, Seal Beach, CA (US)

Correspondence Address: AKIN GUMP STRAUSS HAUER & FELD, 1900 FROST BANK PLAZA, 816 CONGRESS AVENUE, AUSTIN, TX, 78701

(21) Appl. No.: 09/733,788

(22) Filed: Dec. 7, 2000

(51) Int. Cl. H04N 9/73

(52) U.S. Cl. 348/222; 348/223

(57) ABSTRACT

A color imaging system is provided that captures an image in a color format that comprises a plurality of chromatic intensity values, detects whether the image is substantially achromatic (i.e., gray-scale or black and white), and renders the chromatic intensity values as grayscale luminance or black and white values. A color imager comprising an array of color photocells captures the image. An image processor is provided with a white balance circuit, a gray-scale image detection circuit, and an image conversion circuit. The white balance circuit adjusts the chromatic values to correct for non-ideal sources of white light illumination. The gray-scale image detection circuit detects whether the image is substantially achromatic. The image conversion circuit renders the image as a gray-scale or black-and-white image, as the circumstances dictate.

### BACKGROUND OF THE INVENTION

1. Technical Field.

The present invention relates in general to color image processing, and in particular to a system and method for obtaining a high-resolution gray-scale image using a color image capture device.

2. Related Art.

Color imagers are often preferred over black-and-white or gray-scale imagers for the obvious reason that color imagers are able to reproduce both color, gray-scale, and black-and-white images. Many color imagers, however, are not as efficient or accurate at capturing achromatic images as gray-scale imagers.

Digital imagers typically comprise an array or grid of photocells, each of which produces an electrical response proportional to the light focused upon it. In gray-scale digital imagers, each pixel is typically represented by a single photocell. In color digital imagers, by contrast, each pixel is typically represented by a triplet of adjoining photocells, each of which is covered by a red, green, or blue filter. Accordingly, reproduction of an image captured by a color imager, unlike a gray-scale imager, typically requires interpolation of the nearest red, green and blue photocell values.

Interpolation, of course, results in blurring of the image. Accordingly, an achromatic image captured by a gray-scale imager will typically have better quality and resolution than the same image captured with a color imager having the same number of photocells. In short, the red, green, and blue filters utilized in a color imager reduces the device's inherent pixel resolution.

An unsatisfactory way to resolve an achromatic image captured by a color imager to its inherent photocell resolution, without blurring or interpolation, is to simply treat each red, green, and blue (RGB) photocell as if it were an unfiltered photocell. This would assume that the electrical response of a red-filtered photocell to an image illuminated by a white light source is the same as that of a green- or a blue-filtered photocell. This assumption, however, fails with most white-light sources.

Perfect white light contains a continuous and equally-proportioned distribution of the visible frequencies of light. In other words, a graph of the luminance of perfect white light versus its spectral frequency would be a horizontal line. Color, including the color white, is essentially a perceptual characteristic of light. Accordingly, there are many sources of light that appear white even though their spectral characteristics are discrete or skewed toward one end or the other of the visible spectrum.

For example, white light from the midday sun has a higher proportion of blue light than light from the sunrise or the sunset, which is dominated by the reddish components of the visible spectrum. Likewise, white light from a fluorescent bulb typically has a higher proportion of blue or green light than white light from an incandescent bulb.

The brain compensates for many skewed sources of white light, sources of white light that do not consist of an equal and continuous mixture of the visible frequencies of light, by making such sources appear white even though they are not. A typical imager, however, does not make the same correction. Accordingly, an image captured of a scene illuminated by an incandescent bulb will typically appear significantly redder than an image captured of the same scene in the midday sun, although to the naked eye the scene may look alike under the two sources of illumination.

The dominant color of a light source is conventionally quantified in terms of color temperature. The color temperature of a light source is the temperature, in degrees Kelvin, to which a very black body must be heated to radiate light with similar spectral characteristics. The color temperature scale ranges from lower color temperatures of reddish light to higher color temperatures of bluish light.

The color temperature of an overcast sky is approximately 6,700° to 7,000° K. The color temperature of an electronic flash is typically approximately 6,200° to 6,800° K. The color temperature of a daylight fluorescent bulb is typically approximately 6,300° K. The color temperature of direct midday sunlight is approximately 5,000° to 6,000° K. The color temperature of early morning/late evening daylight is approximately 5,000° to 5,500° K. The color temperature of a typical 100 Watt incandescent bulb is typically approximately 2,900° K.

The color temperature does not, of course, fully describe the spectral characteristics of a light source. An equally-proportioned mixture of discrete wavelengths of red, green and blue light may create the same appearance of white light as an similarly-proportioned but more continuous mixture of light. Objects illuminated by a mixture of discrete wavelengths of visible light, however, may often appear dull or washed out.

To compensate for different sources of white light, photographers sometimes place colored filters over their camera lenses. For example, a bluish filter may be used to counteract the excessive red of an incandescent light. A different-colored filter may be used to counteract the excessive bluish or greenish tint of a fluorescent light Professional television cameras may include color filter wheels which are rotated behind the camera lens.

Some digital cameras include white-balance features which calibrate the camera's circuits so that the red, green, and blue values are equalized when a picture is captured of an illuminated white piece of paper or of a milky lens cap. More sophisticated digital cameras include continuous white-balance features that automatically sense the red minus luminance (R-Y) and blue minus luminance (B-Y) values, map those values to a look-up table to guess whether the illumination source is white light, and, if it is so determined, calibrate the circuits to equalize the red, green, and blue values.

Other problems, disadvantages, and shortcomings of prior art systems can be appreciated by one of skill in the art after examination of such prior art and in view of the present disclosure.

### SUMMARY

A color imaging system is provided comprising a color imager and an image processor. The color imager has a plurality of photocells producing an electrical response that corresponds to a chromatic intensity value. The electrical responses from the plurality of photocells together comprising a captured color image. The image processor determines whether the captured image is substantially achromatic, and if so, renders each of the electrical responses as an achromatic luminance value. The image processor may also automatically white-balance the substantially achromatic image.

The invention also provides a white balance circuit that modifies the chromatic intensity values to compensate for imperfect sources of illumination that lack an equal and continuous mixture of the visible frequencies of light. Also provided may be an image conversion circuit that renders each of said plurality of chromatic intensity values as an achromatic luminance value if the achromatic image detection circuit detects that the image is substantially achromatic. Also, a circuit may be provided that detects whether the image is a substantially black-and-white image and a circuit that renders said plurality of chromatic intensity values as black and white values if the image is detected to be a substantially black-and-white image.

The invention provides a method of processing an image that may capture a plurality of chromatic intensity values. This method comprises determining whether the plurality of chromatic intensity values comprises a substantially achromatic image, and converting the plurality of chromatic luminance values to a plurality of achromatic luminance values if the plurality of chromatic luminance values are determined to comprise a substantially achromatic image.

Other systems, methods, features and advantages of the invention will be or will become apparent to one with skill in the art upon examination of the following figures and detailed description. It is intended that all such additional systems; methods, features and advantages be included within the description, be within the scope of the invention, and be protected by the accompanying claims.

### BRIEF DESCRIPTION OF THE FIGURES

The components in the figures are not necessarily to scale, emphasis instead being placed upon illustrating the principles of the invention. Moreover, in the figures, like reference numerals designate corresponding parts throughout the different views.

FIG. 1 is a functional block diagram illustrating a color imaging system with enhanced resolution capabilities for achromatic images, including image processing circuitry.

FIG. 2 is a functional flow diagram illustrating an exemplary operation of the image processing circuitry of FIG. 1

FIG. 3 is a functional block diagram of a portion of one embodiment of a white balance circuit.

FIG. 4 is a functional flow diagram illustrating an exemplary operation of the gray scale image detection circuit.

FIG. 5 is a histogram of a color saturation distribution of a hypothetical image captured of an essentially achromatic scene or object.

FIG. 6 is a functional flow diagram illustrating an exemplary operation of a black and white image detection circuit.

FIG. 7 is a histogram of a luminance distribution of a hypothetical image captured of an essentially black-and-white scene or object.

FIG. 8 is a functional flow diagram illustrating an exemplary operation of a color to gray-scale image conversion circuit.

FIG. 9 is a functional flow diagram illustrating an exemplary operation of a color to black-and-white image conversion circuit.

### DETAILED DESCRIPTION

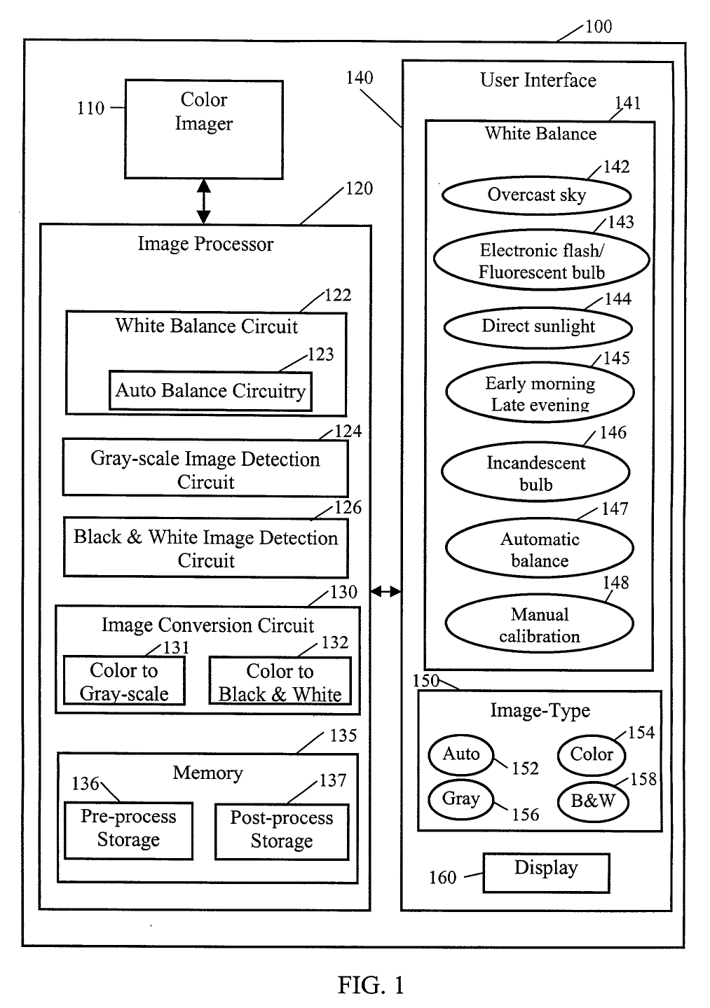

FIG. 1 is a functional block diagram illustrating a color imaging system 100 with enhanced resolution capabilities for achromatic images, built in accordance with the present invention. The color imaging system 100 comprises a color imager 110 and an image processor 120. The color imager 110 is any device suitable for capturing an image. Such devices include digital still cameras, digital video cameras and scanning devices, of both the complimentary metal oxide semi-conductor (CMOS) and charge-coupled device (CCD) type. Imagers 110 of the CMOS-type can be integrated with CMOS-based image processing circuitry 120 on the same semi-conducting wafer.

The color imaging system 100 may comprise a single apparatus such as a camera, or alternatively, may comprise a plurality of separate devices that transfer information to one another through a network, cable, wireless connection, removable memory storage device, or other suitable means. Likewise, the image processor 120 may be disposed in a single or multiple integrated circuits, in combination with the imager 110, or on a single die.

After a color image is captured by the image capture device 110, it is delivered to the image processing circuitry 120 in digital form. Alternatively, the image processing circuitry 120 is configured to receive the image in analog form and to convert the same into digital form. The image may be a still picture or a video frame.

The image processing circuitry 120 includes an image conversion circuit 130 and memory 135. The image conversion circuit 130 comprises a color to gray-scale circuit 131 and a color to black-and-white circuit 132. Memory 135 includes post-process storage 137 for storing the image between or after various image-processing steps. Memory 135 also comprises, but optionally need not comprise, pre-process storage 136 for storing the image before an image-processing step. The image processing circuitry 120 also utilizes, but optionally need not utilize, the color image capture device 110 itself for pre- or post-processing memory storage. Image processing circuitry 120 also comprises a white balance circuit 122, a gray-scale image-detection circuit 124 and a black-and-white image-detection circuit 126.

The white balance circuit 122 comprises auto balance circuitry 123 that automatically white balances the image. Auto-balancing involves calculating the red minus luminance (R-Y) and blue minus luminance (B-Y) values of the image and comparing those values to data in a look-up table in memory 135. The look-up table stores combinations of R-Y and B-Y values that correspond with light that the brain interprets as white. If the R-Y and B-Y values fall within a predetermined “white light” range, the white balance circuit 122 adjusts its red, blue and green circuits to make the R-Y and B-Y signals add up to white. Else, the image is processed as a color image, and no calibration is performed to equalize the RGB values.

The gray-scale image-detection circuit 124 detects whether the captured image is gray-scale or color by evaluating one or more distributions of image color characteristics to detect patterns consistent with an achromatic image. Color characteristics that may be evaluated by the gray-scale image-detection circuit 124 include the color saturation or hue of the image. Distributions showing a consistent hue or a low color saturation are consistent with a gray-scale image. Alternatively, the gray-scale image-detection circuit 124 computes a distribution representing the relative differences between the values of adjoining red, green, and blue photocells. Narrow distributions of such differences, or distributions showing predominantly small differences, are consistent with an achromatic image.

The black-and-white image detection circuit 126 detects whether the captured image is approximately black and white by evaluating one or more distributions of image color characteristics to detect patterns consistent with a black-and-white image. Color characteristics that may be evaluated by the black-and-white image-detection circuit 126 include the luminance or individual red, green, and blue values of the image. Double-peaked distributions of such values are consistent with a black-and-white image.

The color imaging system 100 also optionally includes a user interface 140 with a white balance control 141, an image-type specification control 150, and,a display 160. The interface 140 may comprise one or more switches, keypads, keyboards, buttons, stylus pad, pointing device, voice control, or any other mechanism suitable for receiving user input. The white balance control 141 permits a user to control white-balance settings. The image-type specification control 150 permits a user to specify whether a captured image should be resolved as a color image, a gray-scale image or a black-and-white image. The display 160 supports viewing and instant acceptance or modification of a captured image.

The white balance control 141 provides seven white-balance settings for purposes of illustration, although different combinations of white-balance settings could be incorporated without departing from many aspects of the present invention. The seven settings provided by the exemplary embodiment include an overcast-sky setting 142, an electronic-flash/fluorescent-bulb setting 143, a direct-sunlight setting 144, an early-morning/late-evening setting 145, an incandescent-bulb setting 146, an automatic-balance setting 147, and a manual-calibration setting 141.

Settings 142 through 146 provide preset calibration values for the corresponding light settings. Manual-calibration setting 148 permits the user to manually enter values to equalize (or, if preferred, to skew) the red, green, and blue values of the image. Alternatively, under manual-calibration setting 141, the white balance circuitry 122 calibrates its red, green and blue values based on the values received from an image captured of a white sheet of paper or other white background. The automatic balance setting 147 directs the white balance circuitry 122 to automatically calibrate the white balance without requiring a prior image capture of a white background for calibration purposes.

The image-type specification control 150 comprises four settings. Automatic setting 152 directs the image processing circuitry 120 to utilize a gray-scale image-detection circuit 124 or a black-and-white image-detection circuit 126 to detect the type of image being captured. Color setting 154 directs the image processing circuitry 120 to not convert the image to gray scale or black and white. Gray-scale setting 156 directs the image processing circuitry 120 to convert the image to gray scale. Finally, black-and-white setting 158 directs the image processing circuitry 120 to convert the image to black-and-white. While the exemplary embodiment provides four such settings for purposes of illustration, different combinations of type-specification settings could be incorporated without departing from many of the aspects of the present invention.

While the exemplary embodiment includes many different components, configurations, and settings, not all of them are limiting. A color imaging system that omits, substitutes, modifies, or supplements one or more of the various components of the exemplary embodiment would not detract from many of the aspects of the present invention. For example, the white balance control 141 and auto-balance circuitry 123 need not be included. For example, a scanner which uses the same light source, the white balance characteristics of which are known, for every image that is scanned, may or may not include an adjustable white-balance control 141 and white balance circuit 120. Furthermore, the RGB values may be pre-calibrated, using digital or analog amplification, within the color image capture device 1 10 itself.

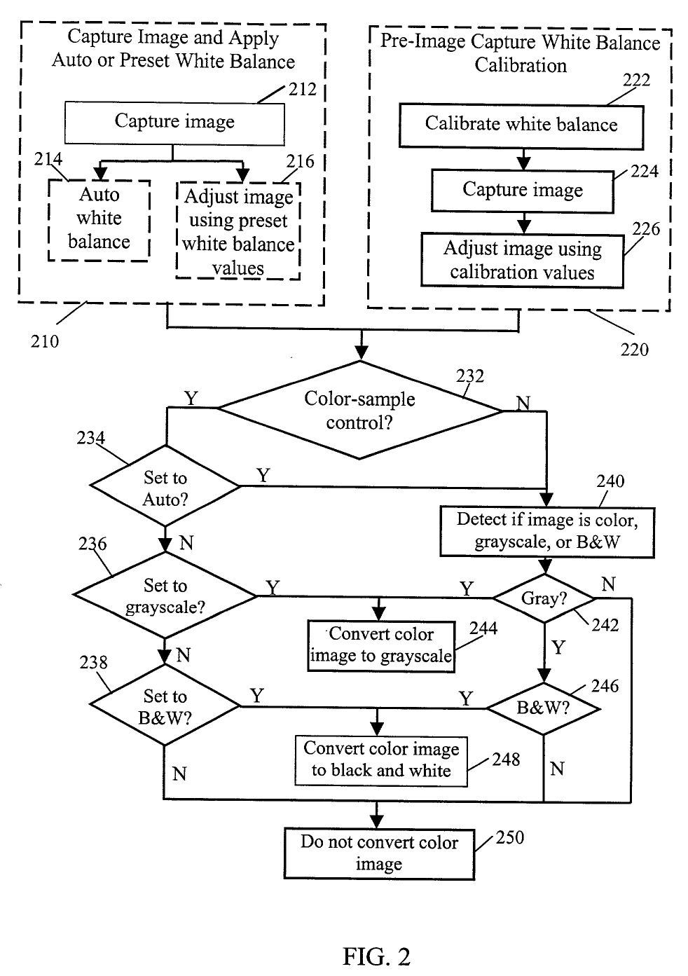

FIG. 2 is a functional flow diagram illustrating an exemplary operation of the image processing circuitry 120 of FIG. 1. In one configuration of the color imaging system 100, white balance correction is performed by calibrating the RGB or other primary color values based on an image capture of a white sheet of paper or other white object illuminated by the image light source. In another configuration, white balance correction is performed by applying a preset white balance adjustment based on the white-balance-setting control switch 140 selection. In yet another configuration, white balance correction is performed by, automatically determining a white balance adjustment. These various alternatives are represented by function blocks 210 and 220.

In function block 210 the image is first captured, as illustrated in block 212. Then, in block 214, various image characteristics are evaluated to automatically adjust the white balance of the image. Alternatively, in block 216, the image data is white-balanced using calibration values corresponding to a pre-selected white light-source setting.

In function block 220, white balance is achieved by, in block 222, calibrating the white balance, in block 224, capturing the image, and in block 226, modifying the RGB (or other primary color) values of the image using the calibration values determined in block 222. The calibration of block 222 can be accomplished by taking a picture of a white sheet of paper using the same illumination source as the scene to be captured.

The block following the blocks executed in either function block 210 or function block 220 depends on whether or not the color imaging system 100 (FIG. 1) includes an image-type specification control with the user interface 140 (FIG. 1) that permits selection of color, gray-scale, or black-and-white. This contingency is expressed in condition block 232.

If there is an image-type specification control, then the selected specification is evaluated. If set to automatic, as illustrated by evaluation block 234, in block 240 the image processing circuitry 120 detects if the image is color, gray scale or black and white. If set to render the image as a gray-scale image, as illustrated by evaluation block 236, then the image is converted from color to gray-scale values, as shown in block 244. If set to black and white as illustrated in evaluation block 238, then in block 248 the image is converted from color to black and white. If there is no image-type specification switch 150, then in block 240 the circuit 200 detects if the image is in color, gray scale, or black and white. If the circuit 200 determines that the image is a gray-scale image, as illustrated in evaluation block 242, then in block 244 the image converted from color to gray scale. If the circuit 200 detects that the image is in black and white as illustrated in evaluation block 246, then in block 248 the image is converted from color or gray scale to black and white. If in block 240 it is determined that the image is neither gray scale nor black and white, then in block 250 the color image is not converted.

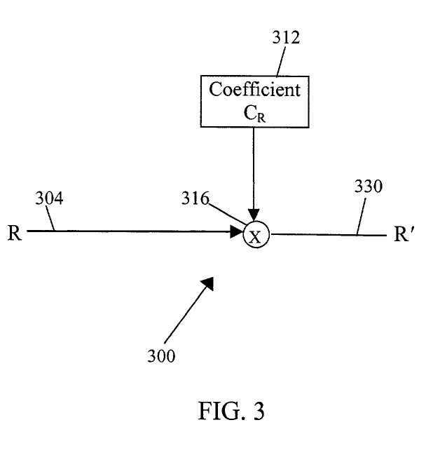

FIG. 3 is a functional block diagram of a portion of one embodiment of a white balance circuit 122 of FIG. 1. In this exemplary embodiment, a white balance circuit 300 operates by multiplying each red, green, or blue photocell value by one of three red, green, or blue white-balance coefficients. The coefficients are determined by stored or computed calibration values for different lighting conditions, for example, the computed or stored values corresponding to switch settings 141-147 (FIG. 1). Alternatively or additionally, the coefficients are determined by sampling the color space and applying a suitable error minimization formula to obtain maximum color fidelity. FIG. 3 illustrates only the portion of the white balance circuit 300 carrying out the equation R′=C_{R}˜R. The white balance circuit 300 adjusts the RGB values of the image without interpolating nearby pixel data. The input red value 304 is converted from unsigned to signed format, multiplied by coefficient C_{R} 312 using multiplier circuit 316 to produce a white-balanced R′ value 330. Green and blue photocell values G′ and B′ are white-balanced in similar fashion, using identical or similar circuitry.

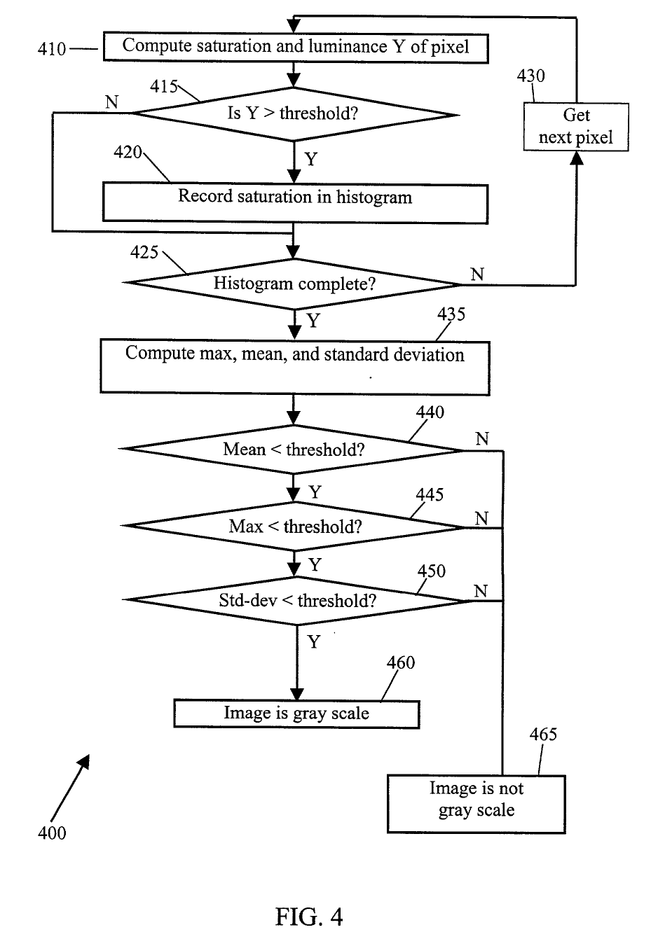

FIG. 4 is a functional flow diagram of one embodiment of the gray-scale image-detection circuit 124 of FIG. 1. In blocks 410 through 430, a histogram of the distribution of the color saturation values of the image's pixels is computed. In block 410, both the color saturation and the luminance Y of a pixel is computed. This typically requires conversion of the pixel data from RGB (or other primary color) format to a color space based upon polar chromaticity and cartesian luminance values. The luminance Y is computed to filter out extremely dark pixels for which the color saturation value is not reliable. In block 415, the luminance Y is compared to a preset threshold. If it exceeds the threshold, then in block 420 the saturation value for that pixel is recorded within the histogram. In block 425, an indexing value is evaluated to determine whether the histogram is complete. If not, in block 430 the next pixel is retrieved, and the histogram-creating process of blocks 410 through 430 is repeated until the histogram is complete.

After the histogram is complete, in block 435, the maximum and mean color saturation values of the histogram are computed. The standard deviation of the color saturation distribution is also computed. In block 440, the mean color saturation value is compared with a second threshold value. In block 445, the maximum color saturation value is compared with a third threshold value. In block 450, the standard deviation of the color saturation distribution is compared with a fourth threshold value. If the second, third, and fourth threshold values exceed the mean, maximum, and standard deviation values, respectively, then in block 460 it is determined that the image is a gray-scale image. If these conditions are not met, then in block 465 it is determined that the image is not a gray-scale image. Other histograms may be computed and other comparisons made without departing from the essence of the invention.

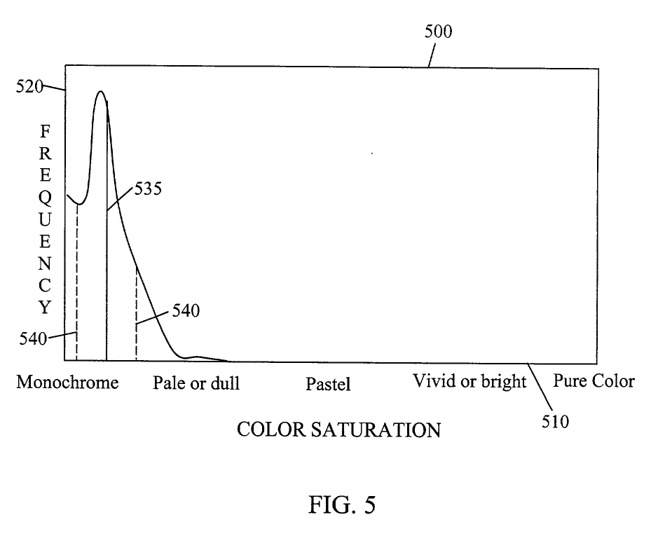

FIG. 5 is a histogram 500 of a color saturation distribution of a hypothetical image captured of an essentially achromatic scene or object. The X-axis 510 of histogram 500 represents the color saturation of the pixels going from monochrome to pure color. The Y-axis 520 of histogram 500 represents the number of pixels in a given image having a given color saturation value. The mean color saturation value 535 is represented by a solid line and the standard deviation 540 from the mean is represented by dashed lines.

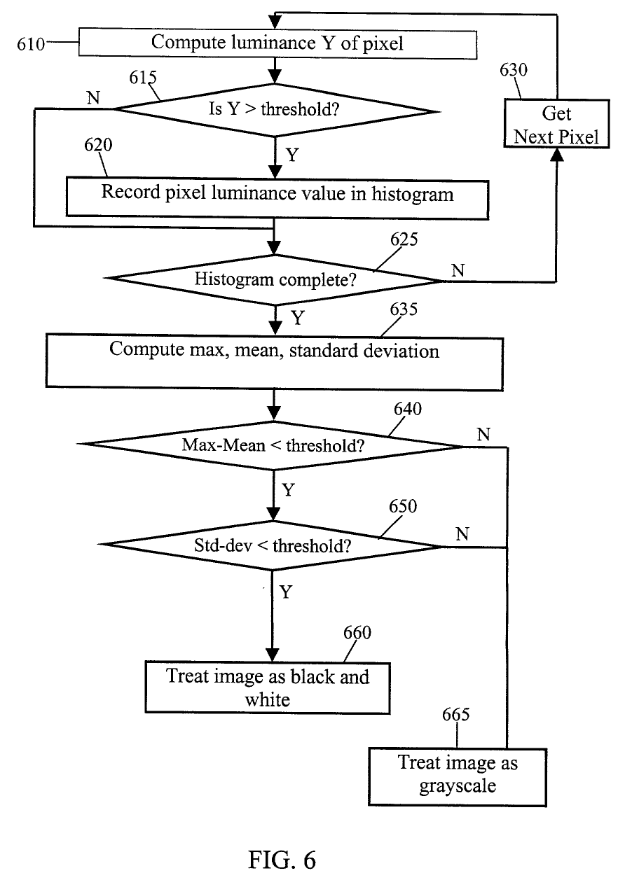

FIG. 6 is a functional flow diagram of one embodiment of the black and white image detection circuit 126 of FIG. 1. In blocks 610 through 630, a histogram of the luminance distribution of the image's pixels is computed. In block 610, the luminance Y of a pixel is computed. In block 615, the luminance Y is compared with a threshold value. If it exceeds that threshold value, then in block 620 the luminance value for that pixel is recorded within the histogram. In block 625, an indexing value is evaluated to determine whether the histogram is complete. If not, in block 630 the next pixel is retrieved, and the histogram-creating process of blocks 610 through 630 is repeated until the histogram is complete.

After the histogram is complete, in block 635, the mean and maximum luminance values of the histogram are computed. The standard deviation of the luminance distribution is also computed. In block 640, the difference between the maximum and mean luminance values is compared with a second threshold value. In block 650, the standard deviation of the luminance distribution is compared with a third threshold value. If the difference between the maximum and mean values is less than the second threshold value, and the standard deviation of the luminance distribution is less than the third threshold value, then in block 660 it is determined that the luminance distribution of the image is consistent with that of a black-and-white image. If these conditions are not met, then in block 665 it is determined that the image is not a black-and-white image. Of course, other histograms may be computed and other comparisons made without departing from the essence of the invention.

The exemplary embodiment for detecting whether the image is black and white is quite similar to the exemplary embodiment for detecting whether it is gray scale. Accordingly, in another embodiment (not shown), the two circuits are combined as one.

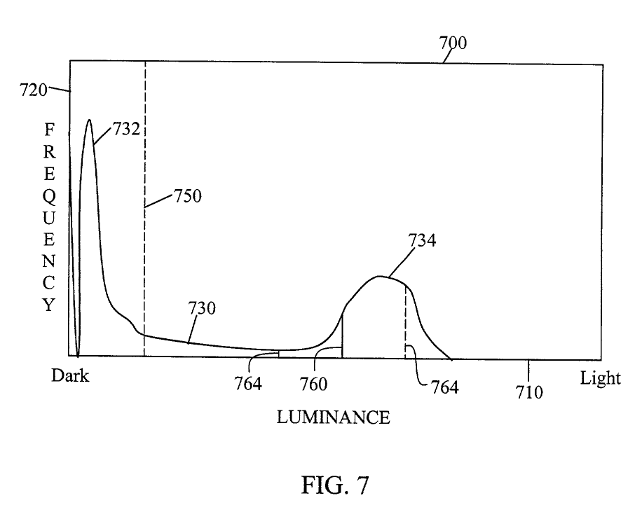

FIG. 7 is a histogram 700 illustrating a luminance distribution 730 of a hypothetical image captured of an essentially black-and-white scene or object. The X-axis 710 of graph 700 is represented by the luminance. The Y-axis 720 represents the frequency of pixels having a given luminance. Luminance distribution 730 has a darkness peak 732 and a brightness peak 734. In the embodiment of FIG. 6, darkness peak 732 would not be recorded in the histogram 700 because its luminance values fall below the threshold 750. Pixels with luminance values below threshold 750 would be assumed to be black. Above the threshold 750, the luminance distribution 730 has a relatively gaussian distribution, suggesting that the image is black and white.

The mean 760 of the luminance distribution 730 falling to the right of threshold 750 is represented by a solid line. The standard deviation 764 from the mean 760 is represented by dashed lines. The portion of the luminance distribution 730 between the threshold 750 and the brightness peak 734, representing gray values, corresponds to the edges between the black and white portions of the captured image.

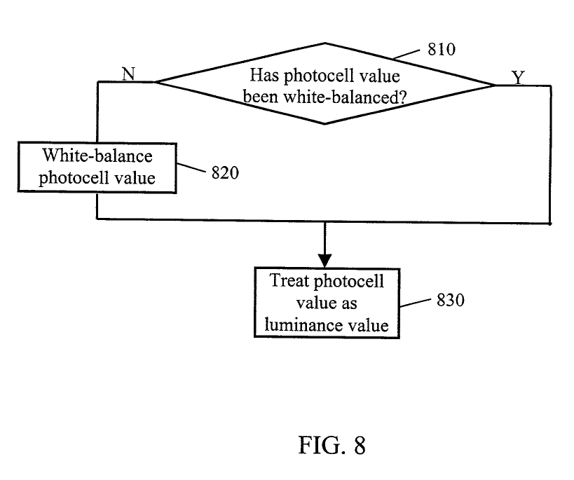

FIG. 8 is a functional flow diagram of one embodiment of a color to gray-scale image conversion circuit 131 of FIG. 1. If no white-balance-correction has been applied to the image, as illustrated in condition block 810, then in block 820 the photocell is white-balance adjusted. Next, or if white-correction has been applied to the image, in block 830 the photocell value is treated as a single pixel luminance value, rather than as an RGB component of a pixel comprised of three adjoining photocells. As a result of this conversion, the image's chromatic information is disregarded.

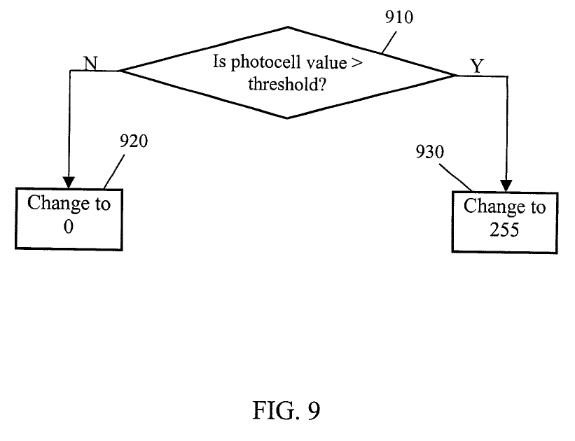

FIG. 9 is a functional flow diagram of one embodiment of a color to black-and-white image conversion circuit 132 of FIG. 1. In block 910, each photocell value is compared with a threshold. If the photocell value is greater than the threshold, then in block 930 the photocell value is changed to a white value such as 255, assuming that the photocell values are represented by a single byte. If not, in block 920 the photocell value is set to a black value such as 0. Of course, the particular numbers chosen to represent white or black are arbitrarily assigned.

While various embodiments of the application have been described, it will be apparent to those of ordinary skill in the art that many more embodiments and implementations are possible that are within the scope of this invention. Accordingly, the invention is not to be restricted except in light of the attached claims and their equivalents.

What is claimed is:

1. A color imaging system comprising:
a color imager having a plurality of photocells producing electrical responses that correspond to chromatic intensity values, and the electrical responses from the plurality of photocells together comprising a captured color image; and
an image processor that determines whether the captured image is substantially achromatic, and if so, renders each of the electrical responses as an achromatic luminance value.

2. The color imaging system of claim 1, wherein the image processor further white-balances the substantially achromatic image.

3. The color imaging system of claim 1, wherein the image processor automatically white-balances the substantially achromatic image.

4. The color imaging system of claim 1, wherein the substantially achromatic image is a gray-scale image, and the achromatic format is a gray-scale format.

5. The color imaging system of claim 1, wherein the substantially achromatic image is a black-and-white image, and the achromatic format is a black-and-white format.

6. The color imaging system of claim 1, wherein the color image capture device is a scanner having a constant, known light source.

7. The color imaging system of claim 1, wherein the color image capture device and image processing circuitry are disposed within a single device.

8. The color imaging system of claim 1, further comprising a switch that allows a user to select from among a plurality of white-balance settings.

9. The color imaging system of claim 1, further comprising an image-type specification control that allows a user to select from among a plurality of image formats that determine how the achromatic image is rendered.

10. An image processor that processes an image comprising a plurality of chromatic intensity values, comprising:
a white balance circuit that modifies the chromatic intensity values to compensate for imperfect sources of illumination that lack an equal and continuous mixture of the visible frequencies of light;
an achromatic image-detection circuit that detects whether the image is substantially achromatic; and
an image conversion circuit that renders each chromatic intensity value as an achromatic luminance value if the achromatic image detection circuit detects that the image is substantially achromatic.

11. The image processor of claim 10, wherein the white balance circuit evaluates a prior image to compute a set of values with which to modify the primary color intensity values.

12. The image processor of claim 10, wherein the white balance circuit evaluates the image to compute a set of values with which to modify the chromatic intensity values of the image.

13. The image processor of claim 10, further comprising a color imager that captures the image.

14. The image processor of claim 10, wherein the achromatic image-detection circuit detects whether the image is a substantially black-and-white image, and the image conversion circuit renders the plurality of chromatic intensity values as black and white values if the achromatic image detection circuit detects that the image is a substantially black-and-white image.

15. The image processor of claim 14, wherein the image conversion circuit converts each achromatic luminance value that is less than a threshold value to black and converts each achromatic luminance value that is more than the threshold value to white.

16. A method of processing an image that is captured as a plurality of chromatic intensity values, comprising:
determining whether the plurality of chromatic intensity values comprises a substantially achromatic image; and
converting the plurality of chromatic luminance values to a plurality of achromatic luminance values if the plurality of chromatic luminance values are determined to comprise a substantially achromatic image.

17. The method of claim 16, further comprising capturing the image with a color imager having a plurality of photocells producing electrical responses corresponding to the plurality of chromatic intensity values.

18. The method of claim 16, further comprising detecting whether the image is a substantially black-and-white image, and if the image is detected to be a substantially black-and-white image, converting the plurality of chromatic luminance values to a plurality of black and white values.

19. The method of claim 16, further comprising the steps of computing mean and standard deviation values of a color saturation distribution of the image, and comparing the mean and standard deviation values to a plurality of threshold values to detect whether the image is substantially achromatic.

20. The method of claim 16, further comprising the steps of computing mean and standard deviation values of a luminance distribution of the image, and comparing the mean and standard deviation values to a plurality of threshold values to detect whether the image is a substantially black and white image.

21. A color imaging system comprising:
means for capturing an image as a plurality of chromatic intensity values; and
means for detecting whether the captured image is substantially achromatic, and if so, rendering each of the chromatic intensity values as achromatic luminance values.

22. An image processor that processes an image comprising a plurality of chromatic intensity values, comprising:
means for compensating the image for sources of illumination that lack an equal and continuous mixture of visible frequencies of light;
means for detecting whether the image, after it has been modified by the compensating means, is substantially achromatic; and
if so, means responsive to the detection means for rendering each chromatic intensity value as an achromatic luminance value.

23. A system for processing an image that is captured as a plurality of chromatic intensity values, comprising:
means for determining whether the plurality of chromatic intensity values comprises a substantially achromatic image; and
means for converting the plurality of chromatic intensity values to a plurality of achromatic luminance values if the plurality of luminance values are determined to comprise a substantially achromatic image.
